(19) United States
(12) Patent Application Publication
(10) Pub. No.: US 2003/0072920 A1
(43) Pub. Date: Apr. 17, 2003

(54) Composite wall structure and method of manufacturing same

(76) Inventor: Jacob F. Klinger, West Chester, PA (US)

Correspondence Address: RATNERPRESTIA, P O BOX 980, VALLEY FORGE, PA, 19482-0980, US

(21) Appl. No.: 09/981,394

(22) Filed: Oct. 17, 2001

(51) Int. Cl. B32B 3/20

(52) U.S. Cl. 428/188; 428/174

(57) ABSTRACT

A lightweight high strength rigid composite laminate is disclosed. The composite laminate comprises a polymer substrate having a plurality of passages formed between a top surface and a bottom surface of the polymer substrate; an organic substrate coupled to the bottom surface of the polymer substrate; a water resistant fiber layer bonded to the top surface of the polymer substrate; and a plastic outer layer coupled to the water resistant fiber. The composite laminate may be used in the fabrication of transport containers for the entertainment industry or as a lightweight, high strength building component.

### FIELD OF THE INVENTION

This invention relates generally to laminated structures. More specifically, the present invention relates to a lightweight, high strength composite laminate for use as a structural component.

### BACKGROUND OF THE INVENTION

In the entertainment industry, very expensive and fragile equipment must be transported between a variety of locations in advance of the arrival of an entertainer or group of entertainers. Heretofore, this equipment was packed in heavy-duty wooden boxes or containers in order to afford adequate protection from the rigors of such transport. These conventional containers were fabricated from plywood stock and either painted or covered in a plastic laminate to prevent damage and splintering to the underlying plywood core. Although strong, these conventional containers have a drawback in that they are very heavy even when empty. Furthermore, these conventional wooden containers are subject to moisture penetration thereby seriously effecting the life of the structure and the equipment contained therein.

Another type of conventional shipping container is made from aluminum. Although these containers are lighter in weight than their wooden counterparts, they are significantly more expensive and are susceptible to moisture infiltration. In addition, such containers are generally limited in size and selection due to the fabrication methods employed. Therefore, requiring more containers than would otherwise be necessary and/or being unable to accommodate large or odd sized pieces of equipment.

### SUMMARY OF THE INVENTION

In view of the shortcomings of the prior art, it is an object of the present invention to provide a lightweight high strength laminated material for use in fabricating transportation containers.

The present invention is a rigid composite laminate for use as a container wall comprising a polymer substrate, an organic substrate coupled to the bottom surface of the polymer substrate, a water resistant fiber layer bonded to the top surface of the polymer substrate, and an outer layer coupled to the water resistant fiber.

According to another aspect of the invention, the polymer substrate has a plurality of passages formed between a top surface and a bottom surface of the polymer substrate.

According to a further aspect of the invention, the polymer substrate is formed from propylene or ethylene.

According to still another aspect of the invention, the organic substrate is a processed wood material.

According to yet another aspect of the present invention, the water resistant fiber layer is an olefin fiber polypropylene layer.

These and other aspects of the invention are set forth below with reference to the drawings and the description of exemplary embodiments of the invention.

### BRIEF DESCRIPTION OF THE DRAWINGS

The invention is best understood from the following detailed description when read in connection with the accompanying drawing. It is emphasized that, according to common practice, the various features of the drawing are not to scale.

On the contrary, the dimensions of the various features are arbitrarily expanded or reduced for clarity. Included in the drawing are the following Figures:

FIGS. 1A and 1B are cross sectional views of a first exemplary embodiment of the present invention;

FIGS. 1C-1F are plan views of various aspects of an exemplary embodiment of the present invention;

FIG. 2 is a cross sectional view of a polymer substrate for use in the composite structure according to a second exemplary embodiment of the present invention; and

FIG. 3 is a cross sectional view of a polymer substrate for use in the composite structure according to a third exemplary embodiment of the present invention.

### DETAILED DESCRIPTION

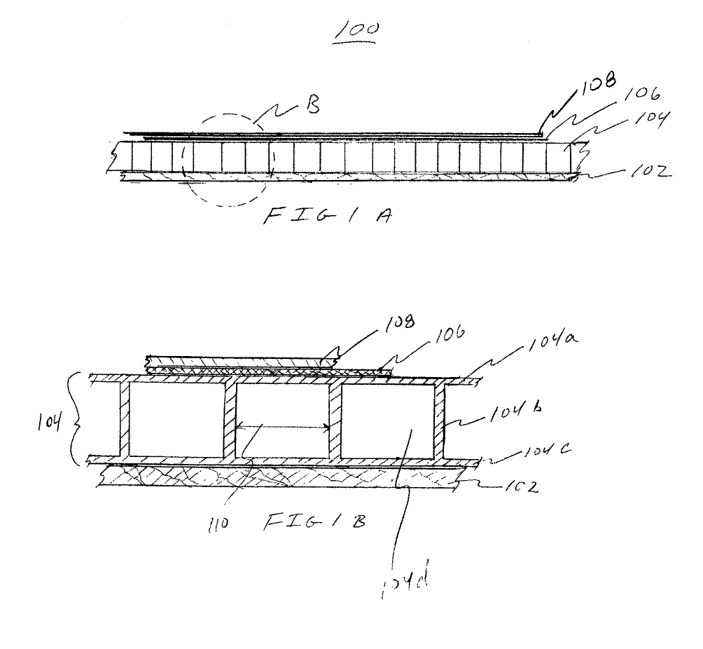

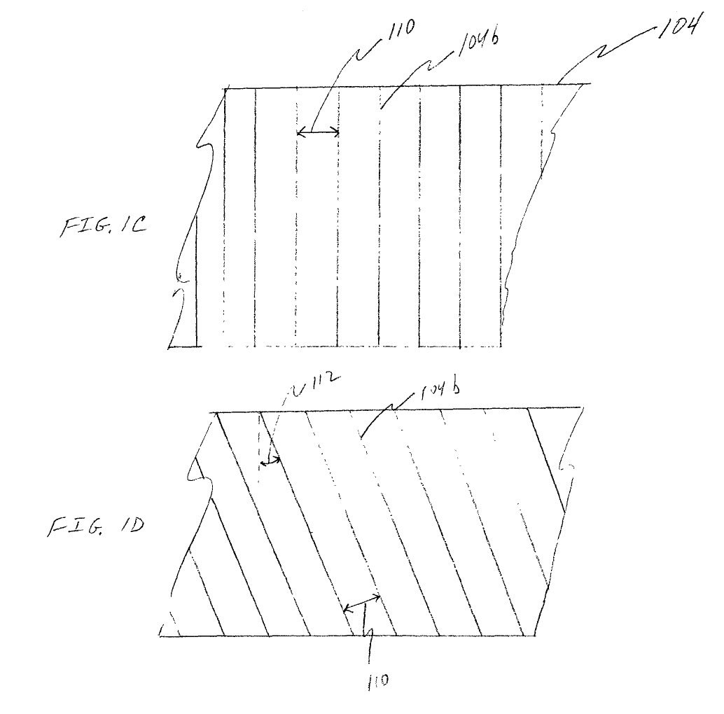

Referring to FIGS. 1A and 1B a cross sectional view of a rigid composite laminate according to the first exemplary embodiment of the present invention is shown. In FIG. 1A, composite laminate 100 has an organic base 102, such as luan or birch plywood, for example. The thickness of organic base 102 may be between about 2.0 and 3.0 mm, and preferably about 2.5 mm. Polymer core 104 is attached to the top surface of organic base 102, preferably using a waterproof adhesive, such as a solid moisture cured urethane, and fibrous layer 106 is attached to the surface of polymer core 104 opposite the surface attached to organic base 102, again preferably using a waterproof adhesive. In addition, an outer layer 108, such as a plastic, is attached to the exposed surface of fibrous layer 106. In one exemplary embodiment, fibrous layer 106 may be about 1 mm thick and may comprise an olefin fiber polypropylene, such as Tyvek®, manufactured by E. I. duPont de Nemours and Company of Wilmington, Del. Using such an olefin fiber polypropylene also protects the underlying structure from moisture infiltration due to its water-resistant nature.

In one exemplary embodiment, outer layer 108 may be an Acrylonitrile-Butadiene-Styrene (ABS) copolymer or other durable material to protect the underlying structure and water-resistant fiber 106 for the abuse associated with transport. The outer layer 108 may include decorative qualities, such as texturing and/or colors, to provide aesthetic appeal, if desired.

Referring to FIG. 1B, a detailed cross sectional view of structure 100 is shown. As shown in FIG. 1B, polymer core 104 has a top surface 104a, bottom surface 104c, and support members 104b extending between bottom surface 104a and top surface 104b. The combination of 104a, 104b and 104c form substantially rectangular passages 104d, having width 110 which may be between about 5 and 10 mm, for example. Rectangular passages 104d extend across the entirety of polymer core 104 (see FIG. 1C) and are substantially parallel to one another. The use of members 104b provides strength to polymer core 104 while significantly reducing the overall weight of polymer core 104. The thickness of polymer core 104 may be between about 5 mm and 15 mm, and preferably about 10 mm. In one exemplary embodiment, polymer core 104 may be formed from a high strength polymer, such as propylene or ethylene, for example.

In another exemplary embodiment, and as illustrated in FIG. 1D, support members 104b may be offset from the longitudinal axis of polymer core 104 by a predetermined angle 112. Angle 112 may be 30 degrees or 45 degrees, for example, as desired.

In yet another exemplary embodiment additional support members 104e may be included which are substantially perpendicular to support members 104b to increase the strength of polymer core 104. FIG. 1E illustrates another exemplary embodiment in which support members 104b, 104d are offset from the axes of polymer core 104. FIG. 1F illustrates yet another exemplary embodiment where support members 104b, 104d are parallel to the axes of polymer core 104.

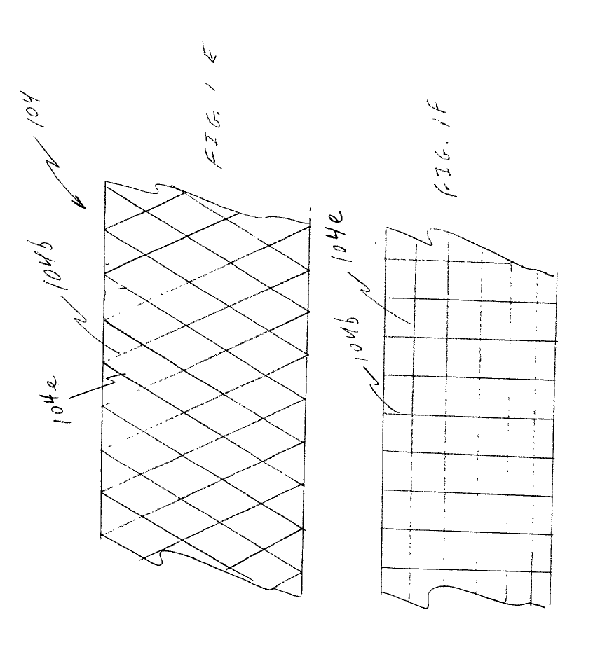

FIG. 2 illustrates a second exemplary embodiment of the present invention. In FIG. 2, polymer core 204 has support members 204b that form substantially triangular passages 204d. As in the first exemplary embodiment, polymer core 204 is attached to organic base 102 and water-resistant fiber 106, which in turn is attached to outer layer 108 (not shown in this figure).

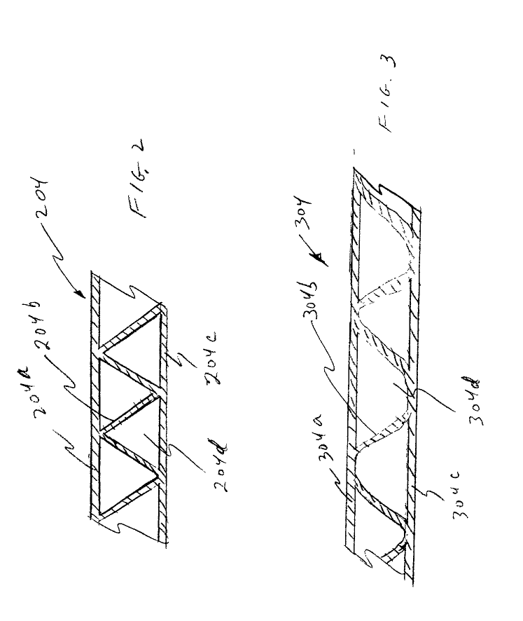

FIG. 3 illustrates a third exemplary embodiment of the present invention. In FIG. 3, polymer core 304 has support members 304b that form a substantially sinusoidal pattern between the upper and lower surfaces 304a and 304c. Once again, as in the first exemplary embodiment, polymer core 304 is attached to organic base 102 and water-resistant fiber 106, which in turn is attached to outer layer 108 (not shown in this figure).

Composite structure 100 may be cut into sheets of any width as desired and utilized to fabricate enclosures, such as light weight, high-strength shipping containers using conventional construction techniques. In addition, composite structure 100 may be used as a substitute for wood products in the construction of various other structures, such as shelving, partitions, etc., as desired.

Although the invention has been described with reference to exemplary embodiments, it is not limited thereto. Rather, the appended claims should be construed to include other variants and embodiments of the invention which may be made by those skilled in the art without departing from the true spirit and scope of the present invention.

What is claimed:

1. A rigid composite laminate for use as a container wall, the structure comprising:
a polymer substrate having a plurality of passages formed between a top surface and a bottom surface of the polymer substrate, the plurality of passages parallel to one another in a first direction,
an organic substrate coupled to the bottom surface of the polymer substrate,
a fibrous layer bonded to the top surface of the polymer substrate, and
an outer layer coupled to the water resistant fiber,
wherein the water resistant fiber layer is disposed between the polymer substrate and the outer layer.

2. The laminate according to claim 1, wherein the passages have a substantially rectangular cross section.

3. The laminate according to claim 1, wherein the passages have a sinusoidal cross section.

4. The laminate according to claim 1, wherein the passages have a triangular cross section.

5. The laminate according to claim 1, wherein the passages extend from a first end of the polymer substrate to a second end of the polymer substrate.

6. The laminate according to claim 1, wherein the polymer substrate is formed from one of propylene and ethylene.

7. The laminate according to claim 1, wherein the polymer substrate has a thickness between about 5 mm and 15 mm.

8. The laminate according to claim 1, wherein the polymer substrate has a thickness of about 10 mm.

9. The laminate according to claim 1, wherein the organic substrate is a processed wood material.

10. The laminate according to claim 1, wherein the organic substrate is plywood.

11. The laminate according to claim 10, wherein the plywood is one of luan and birch.

12. The laminate according to claim 1, wherein the organic substrate has a thickness between about 2 mm and 3 mm.

13. The laminate according to claim 1, wherein the organic substrate has a thickness of about 2.5 mm.

14. The laminate according to claim 1, wherein the outer layer is a plastic.

15. The laminate according to claim 1, wherein the outer layer is an ABS plastic.

16. The laminate according to claim 1, wherein the water resistant fiber layer is an olefin fiber polypropylene layer.

17. The laminate according to claim 1, wherein the water resistant fiber layer is less that about 1 mm thick.

18. The laminate according to claim 1, wherein the organic substrate is bonded to the polymer substrate with a waterproof adhesive.

19. The laminate according to claim 1, wherein the container is formed from a plurality of sheets of the composite wall structure.

20. The laminate according to claim 1, wherein the polymer substrate is formed as a unitary member.

21. The laminate according to claim 1, wherein the fibrous layer is water resistant.

22. A rigid composite sheet structure for use as a container wall, the structure comprising:
a corrugated polymer substrate,
an organic substrate coupled to the bottom surface of the polymer substrate,
a water resistant fiber layer bonded to the top surface of the polymer substrate, and
an outer layer bonded to the water resistant fiber.

23. A rigid composite sheet structure for use as a container wall, the structure comprising:
a polymer substrate having a top surface, a bottom surface and a plurality of partitions coupled between the top surface and the bottom surface,
an organic substrate coupled to the bottom surface of the polymer substrate,
a water resistant fiber layer bonded to the top surface of the polymer substrate, and
an outer layer bonded to the water resistant fiber.

24. The composite sheet structure according to claim 23, wherein the plurality of partitions are substantially parallel to one another.

25. The composite sheet structure according to claim 23, wherein the plurality of partitions are formed at an angle relative to one another.

26. The composite sheet structure according to claim 23, wherein the plurality of partitions are formed substantially orthogonal to one another.

27. A rigid composite sheet structure comprising:
a corrugated polymer substrate having a top surface and a bottom surface,
a wood substrate bonded to the bottom surface of the polymer substrate,
an olefin fiber polypropylene layer bonded to the top surface of the polymer substrate, and
a plastic outer layer bonded to an exposed surface of the olefin fiber polypropylene layer.

28. A method for forming a composite structure comprising the steps of:
providing a corrugated polymer substrate having a top surface and a bottom surface,
bonding an organic substrate to the bottom surface of the corrugated polymer substrate,
bonding a fibrous layer to the top surface of the corrugated polymer substrate, and
bonding an outer layer to an exposed surface of the water resistant fiber layer.
